(19) United States
(12) Patent Application Publication
(10) Pub. No.: US 2011/0016144 A1
(43) Pub. Date: Jan. 20, 2011

(54) Crop Production, Planning, Management, Tracking and Reporting System and Method

(75) Inventors: Jamie Strachan, Salinas, CA (US); James Goudy, Berkeley, CA (US); Alejandro Argueta, San Jose, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Growers Express, LLC, Salinas, CA (US)

(21) Appl. No.: 12/681,152

(22) PCT Filed: Oct. 4, 2008
(86) PCT No.: PCT/US08/78880

§ 371 Date: Oct. 5, 2010

Related U.S. Application Data
(60) Provisional application No. 60/977,637, filed on Oct. 4, 2007.

(51) Int. Cl. G06F 17/30

(52) U.S. Cl. 707/769; 707/812; 707/E17.044; 707/E17.014

(57) ABSTRACT

The present invention industrially relates to a system and method for production, planning, tracking, and reporting of a crop or other agricultural product. More particularly, the present invention industrially relates to crop production, planning, tracking, and reporting by coupling an identification to a crop while simultaneously collecting data throughout the crop growth process. The coupled identification relates the crop to the collected data.

### CROSS-REFERENCE TO RELATED DOCUMENTS

This non-provisional application is based on and claims priority to U.S. Provisional Application Ser. No. 60/977,637, filed Oct. 4, 2007.

### TECHNICAL FIELD

The present invention relates a system and method for production, planning, tracking, and reporting of a crop or other agricultural product.

### BACKGROUND ART

Crop production has existed, obviously, for a very long time. Crops have been grown for consumption for a very long time. However, given this significant time-span of growing crops, there are very real problems that still exist, especially with the bulk production and distribution of crops.

Current crop production, planning, management, tracking and reporting are based on a bulk commodity system. The seeds are planted, a mass system is utilized to grow that seed, a harvesting machine, such as a combine, is used to harvest the crops and to separate the crops. The crop is then moved to a storage facility where it may be cooled, cleaned and packed. Next it is transferred to, ultimately, a market. In the final stage, the individual crop is purchased by a consumer and brought home to be consumed. This tried and true system has changed produce into the modern world we live today.

More specifically, during the production process for fresh produce, products go through different handling stages. The process begins with processing of crop demands, crop planning and scheduling, site selection of a farm or ranch, planting, harvesting, packaging and cooling and distribution. It is necessary to gather and maintain information about produce crop processes and traits to realize added value, ensure integrity of the products, and perform proper reporting of crop activities and traits.

Thus, the modern individual no longer, generally, buys their produce from their neighbor, or grows their own. Crops are grown sometimes on the other side of the world. While this expansion and globalization has lowered prices, increased availability, increased outputs per acre, and many other advantages, there are many disadvantages.

One need not look to far in the past to realize some of these disadvantages. These crops may cause significant health problems. For example, during the most recent outbreak of salmonella, authorities and the producers, sellers, and everyone else in the lines of the selling and distribution of crops, could not pinpoint the source or even the species of crop that caused the salmonella, for a significant amount of time. This failure to identify the source of the salmonella caused immense recalls, product waste and human harm.

Many other problems persist with the large scale production of crops. As shown above, there is a lack of accountability, tracking of quality, where its roots laid, among others, and simply no customized individualized report for that individual product.

Some efforts to track food have been implemented. For example, U.S. Publication No. 20030182144 tracks crops through harvest, but only separates by genetic class and in a fashion not capable of individual crop tracking. These other initiatives allow access to the case or ranch block level but what is needed are reporting services allowing information at the item or package level to be gathered and displayed.

There is also the U.S. Department of Agriculture (“USDA”) which provides standards, guidelines and inspection to help ensure safety. Simply said, this government regulation is not enough. One rotten tomato implicates the rest of the industry when, if identified, one could pinpoint the specific grower, shipper, retailer or specific crop.

What is needed in the art is a system or method for tracking one or more individual crops throughout the entire process to provide better information and data to all entities involved, from the planter to the individual purchasing the product. A system is needed to manage agribusiness production operations and automatically gather crop specific unit level data, e.g. site selection information, pre-planting information, growing information, harvesting information, soil amendment information, chemical application information, food safety information, and quality information, that will be made accessible to growers/producers and downstream users, e.g. customers, consumers, in a presentation format, such as a web-based format.

### SUMMARY OF THE INVENTION

The present invention relates to a system and method for production, planning, tracking, and reporting of a crop or other agricultural product. Specifically, the present invention provides, among other features, a method and system for automated tracking and tracing of fresh produce products. In accordance with this method and system, agribusiness production information is managed and automatically gathered including crop demands, planning and scheduling, site selection, planting, growing, harvesting, packaging, cooling, soil amendments, chemical application, food safety, and quality information. This information or crop data profile is stored and managed in a central database system, which reports are populated from for unit level crop specific information. Each crop data profile is linked to a unique identifier for tracking, tracing and data relation purposes. The data profile is associated with the identifier for later referencing and reporting.

The current invention serves the purpose of consolidating disparate data silos and integrating data communications between different steps and entities responsible in the food growth and production lifecycle, such as: improving and streamlining business operations, saving money, providing quantifiable metrics, and improving overall product quality and nutrition by putting an enterprise-wide focus on accountability and reporting from beginning to end and everything in between. The current invention takes an ingredient tracking approach to agriculture: land, water, soil amendments, seed, environmental factors, harvesting, packing, processing and cooling processes all influence the end product and are managed like ingredients to a manufactured product.

The current invention provides an audit trail through its detailed database of crop information, reducing company exposure to liability and improving the ability to respond immediately and distribute warnings in case they are needed. It dramatically improves investigation details in potential contamination situation. It also narrow the scope of potential recalls to include specific product codes affected, allowing for less waste and a more efficient process.

The current invention improves public safety by ensuring a high level of accountability, testing and quality control, and delivering easy-to-understand ratings. The invention provides real time information associated with product lifecycle information making the need for endless post sales reconciliation limited, real time payroll, real time cultivation reporting, real time harvest reporting, customer sales versus production volume tracking to ensure efficient matching of demands to available-to-harvest, and work order based operations driven by best practice or unique condition rules. The current invention helps build consumer confidence through education and unprecedented access to live harvest, safety, nutrition and quality data about their products, and the people and processes involved in their production.

### BRIEF DESCRIPTION OF THE DRAWINGS

FIG. 1 is a diagram of one embodiment of a system for the current invention.

FIG. 2 is a flow chart of one embodiment of a method for the current invention.

FIG. 3 is a flow chart of an example production to consumption process.

FIG. 4 is a diagram of one embodiment of the implementation of the current invention.

FIG. 5 is a diagram of a user interface of the current invention.

FIG. 6 is a diagram of a user interface of the current invention.

FIG. 7 is a diagram with a sample crop and an enlargement of the coupled identification.

### DESCRIPTION OF THE PREFERRED EMBODIMENT

The present invention relates to a system and method for production, planning, tracking, and reporting of a crop or other agricultural product.

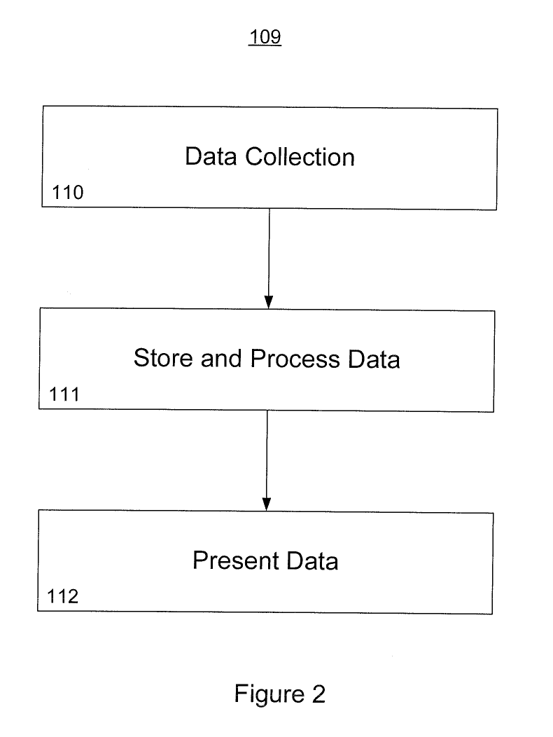

As shown in FIG. 2, the typical method or process 109 is to collect crop data 110, store and process the data 111, and present the data 112.

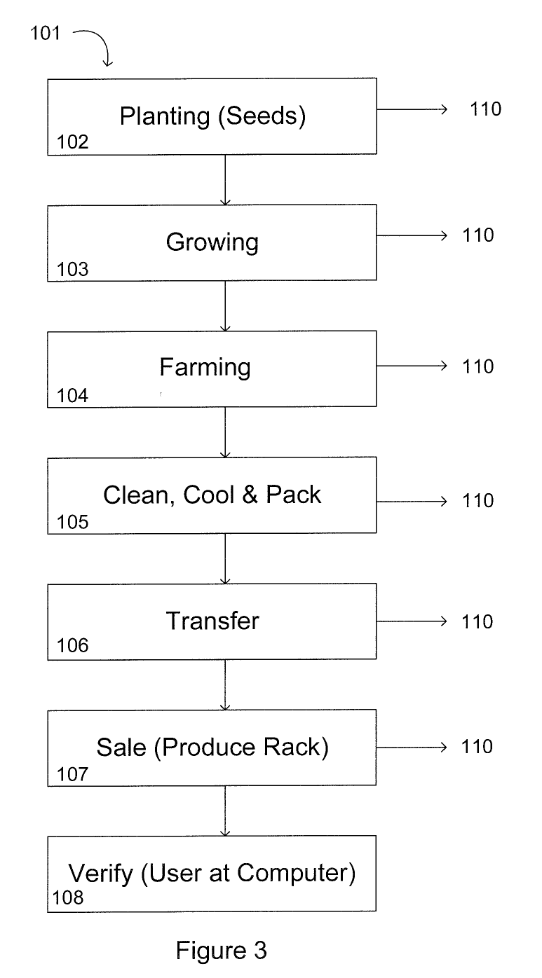

As shown in FIG. 3, the present invention is to optimize the standard crop production and crop tracking process. The typical lifecycle 101 involved in the current invention begins with the planting of the crop 102. This planting data 121 is reported 110 to be stored and processed 111. Next, to have any crop at all, the seed is cultivated, watered and otherwise cared for, in order for it to grow 102. This cultivation process and its related data are also reported 110 to be stored and processed 111. Next, when it is appropriate, the crop is harvested 104 and the harvest data is also reported 110.

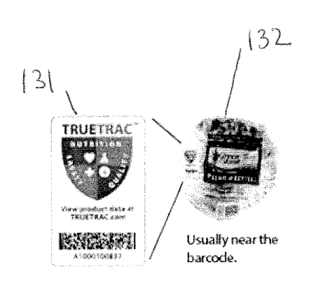

The harvested crops are then cleaned, cooled and packed, or in other words, prepared to be shipped 105. At this point in time the individual crop 132 may be fitted with an identification 131, as shown in FIG. 7. This preparation data 105 is also reported 110. Next, the prepared crops are transferred 106 to, ultimately, their point of sale, whether it be a produce rack at Safeway or a community farmer's market. This transfer data 106 is also reported 110. The crop is then sold 107 to the end user of the product. This data is also reported 110. Finally, because of the collection 110 of one or more of the above data, the end user may verify 108 the safety and quality of the crop they have purchased 107. A retail or commercial user may verify 108 the data as well, e.g. this data may help with the overall retail operation.

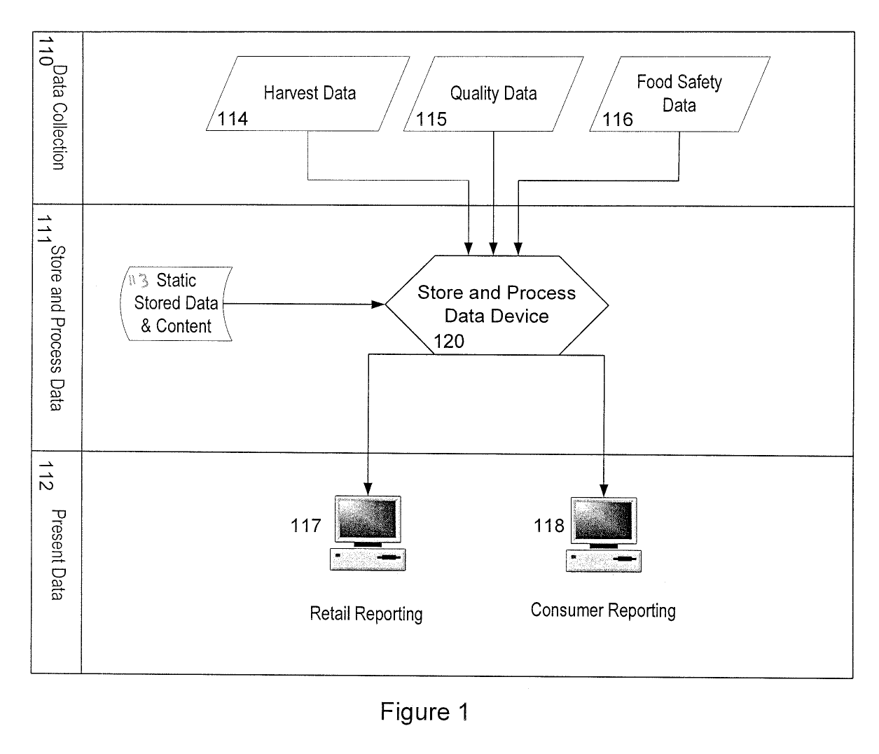

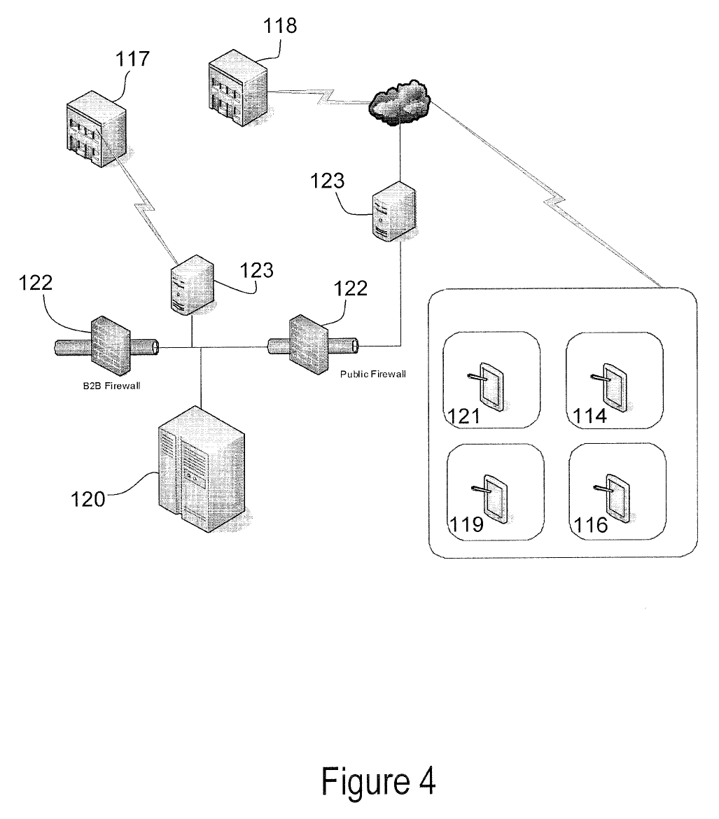

As shown in FIGS. 1-4 the system and method collect data 110. The data collected includes planting data 121, harvest data 114, quality data 115, static data 113, shipping data 119, and food safety data 116, amongst other data. Harvest data 114 may include various components, such as field notes, harvest dates, watering schedules, location longitude and latitude, ranch name, grower name, lot identification, and climate, among many others. Planting data 121 may include seed type, plant date, or planting quantity, among others.

Quality data 115 may include packaging quality, texture data, appearance, color/tone, among others. Food safety data 116 may include lot testing data, microbial analysis, pesticide residue analysis, worker hygiene including their training monitoring and reporting, water quality data and its testing, fertilizer certifications, and the wildlife and environment including ranch risk assessment, pre harvest inspections, and day of harvest inspections.

Static data 113 contains related items that remain static and are not individual crop specific. This may include nutritional facts, such as calorie count, fat count, cholesterol, sodium, carbohydrate, protein data. Further, this data may be compared to other static data, such as how a certain crop variety fits within the food triangle. Also, the static data 113 may include USDA standards or other food safety standards. Shipping data 119 may include shipping dates, destination, quantity, or other retail related data.

All data may be inputted through individual devices, by hand, a general purpose computer, tablets in the field, phones, or any other method of obtaining and inputting data known in the art.

All the above data is then stored and processed 111. It is typically stored in a store and process data device 120. Device 120 may be a general purpose computer or specific components linked together. Typically store and process data device 120 will also utilize a database and a database management system, such as Microsoft SQL Server, which may be coupled to device 120 by shared memory, a local area network, a wide area network, or the Internet.

The data collected 110 can be linked to the store and process device 120 by way of the Internet, a local area network, a wide area network, shared memory, a wireless network, or a cable. If the Internet is used, a firewall 122 may be implemented to protect device 120.

The data may be presented 112 by way of a web browser, such as Mozilla's FireFox, for either a consumer web page 118 or a retail or commercial web page 117. If a web browser is utilized to present 112 the data, a web server 123 is typically utilized. This web server may be the Apache web server. Web server 123 may be coupled to device 120 by shared memory, a local area network, a wide area network, or the Internet

The code and software to populate the web pages may utilize the Microsoft .Net framework. This code and software contains the general .Net framework along with farm specific agents. These software agents may accommodate frequently occurring events, such as adding a farm to the database, planning crop rotations and other farm specific business logic, or data interaction with a farm accounting system.

The code and software also implement modular components, including: a product database table, product specific rules and risks, resource readiness/allocation refinement such as lot administration, production planning/scheduling such as planting scheduling, production process tracking, product harvesting/actual data such as harvest tags, quality assurance/product testing, food safety reporting monitoring and validation, packaging/distribution, and reporting such as software reports and designated web locations. These modules thus deal with the specific areas their title reflects in the system.

This code and software along with the database and database management system make up store and process device 120 that stores and processes the data 111. Web server 123 takes this code and software to display the consumer users 118 and commercial users 117 web pages.

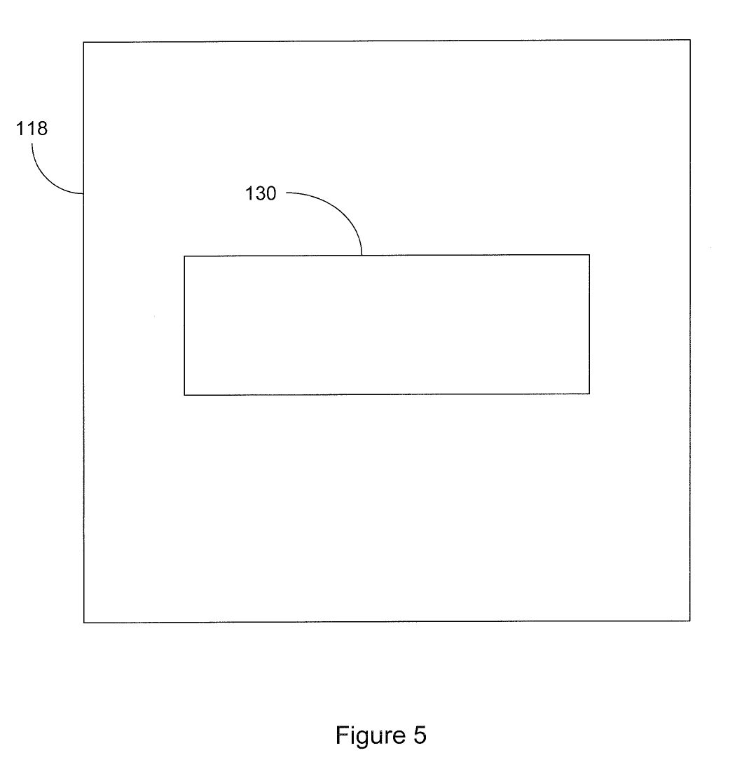

Shown in FIG. 5, the typical consumer web page produced begins with an identification input field 130. In input field 130 the user enters the identification 131 of a purchased crop 132. The web server 123 queries device 120 the information related to the entered identification 131. The user is then taken to the specific web page for that purchased crop 132.

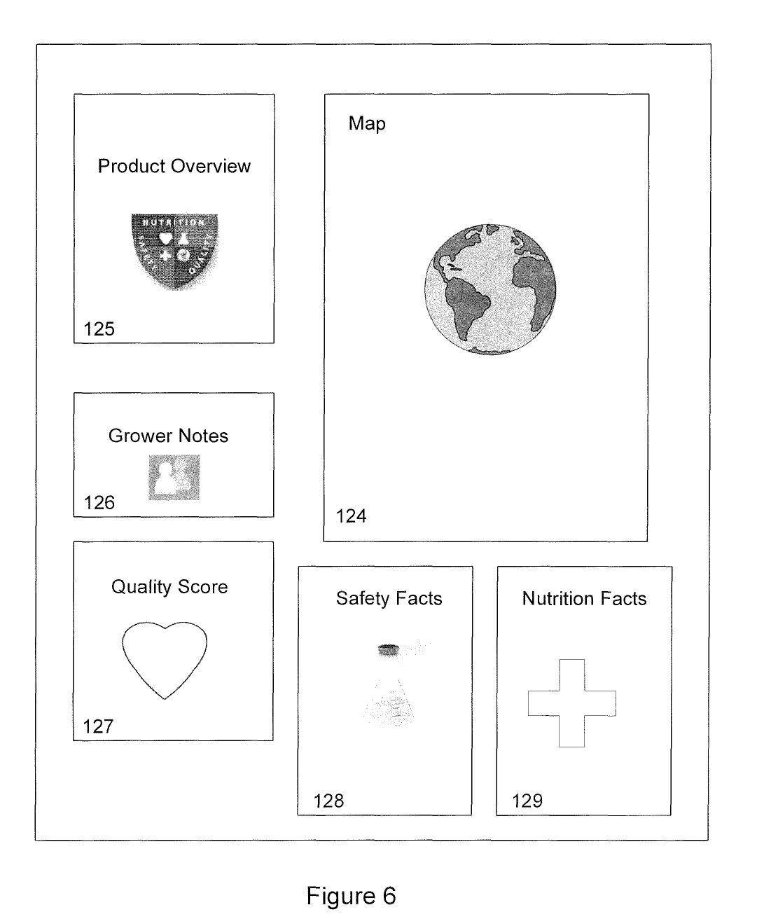

As an example, as shown on FIG. 6, the web page generator for the entered identification 131 will populate the data related to that entered purchased product 132. This data is categorized as product overview data 125, grower notes 126, a quality score 127, a map of the location where the product was grown 124, safety facts 128 and nutrition facts 129. This populated data is related to the stored and processed data. For example, safety facts 128 and nutrition facts 129 may be populated from static data 113. Contrary, quality score 127 is dynamic data based on the individual crop 132 and its identification 131.

As another example, a different web page may be populated for the commercial user of the system and method. This commercial web page 118 may contain data helpful to production of other crops, planting optimization, current and future demands, recall data, financial data, and internal safety information, among others. As with the consumer web page, the data for the commercial web page 117 contains above mentioned data, such as harvest data 114, quality data 115, food safety data 116, shipping data 119, or planting data 121. Further, the commercial web page 118 may contain interactive components, such as the ability to enter a demand for a product, allow a grower to enter their notes or current supply, or other production optimization data, such as the previously planted crop's vitamin and mineral demand.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to he limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Further, no element, component, or method step in the present disclosure is intended to be dedicated to the public regardless of whether the element, component, or method step is explicitly recited in the claims. No claim herein is to be construed under the provisions of 35 U.S.C. §112, sixth paragraph, unless the element is expressly recited using the phrase “means for.”

### INDUSTRIAL APPLICABILITY

The present invention industrially relates to a system and method for production, planning, tracking, and reporting of a crop or other agricultural product. More particularly, the present invention industrially relates to crop production, planning, tracking, and reporting by coupling an identification to a crop while simultaneously collecting data throughout the crop growth process. The coupled identification relates the crop to the collected data.

We claim:

1. A method for crop tracking and crop production comprising the steps:
collecting crop data;
storing crop data in a data repository;
coupling a user interface to said data repository.

2. The method of claim 1 wherein said crop data further comprises a one or more of: safety data, planting data, cultivation data, harvest data, quality data, food safety data, nutritional data, or seed data.

3. The method of claim 1 wherein said user interface is selected from the group comprising:
a web browser, a system native application, an input and output device, a display terminal, printed material, and/or a signal.

4. The method of claim 1 wherein said coupling is selected from the group comprising:
a local area network, shared memory, a wide area network, a cable, a wireless signal, or the Internet.

5. The method of claim 1 wherein said collecting further comprises one or more of:
a harvest global positioning system, an input device, a weather data terminal, a general data input, or a food safety input.

6. The method of claim 1 further comprising:
coupling one or more crop with individual identification;
providing access to said user interface for querying said data repository with said crop's identification for crop specific data.

7. The method of claim 6 wherein said specific crop data further comprises one or more of:
safety data, planting data, cultivation data, harvest data, quality data, food safety data, nutritional data, or seed data.

8. The method of claim 1 further comprising:
analyzing said data repository to optimize crop planting.

9. The method of claim 1 further comprising:
querying said data repository to optimize retail channels.

10. A system for crop tracking and crop production comprising:
crop data inputs, wherein said crop data inputs includes one or more of: safety data, planting data, cultivation data, harvest data, quality data, food safety data, nutritional data, or seed data;
connecting said crop data inputs to a data repository;
coupling a user interface to said data repository;
coupling a crap with an identification;
providing access to said user interface for querying said data repository with said crop's identification for crop specific data.
